(19) United States
(12) Patent Application Publication
(10) Pub. No.: US 2006/0230712 A1
(43) Pub. Date: Oct. 19, 2006

(54) Equine amusement, distraction and chew device

(76) Inventor: Doreen Rose Spinney, Los Angeles, CA (US)

Correspondence Address: Newton E. Brightwell, Esq.;Hoefflin & Associates, Suite 232, 2659 Townsgate Road, Westlake Village, CA, 91361, US

(21) Appl. No.: 11/402,889

(22) Filed: Apr. 13, 2006

Related U.S. Application Data
(60) Provisional application No. 60/671,166, filed on Apr. 15, 2005.

(51) Int. Cl. B68B 1/02; A01K 29/00

(52) U.S. Cl. 54/24; 119/709

(57) ABSTRACT

The present invention is a device used to deter horses from biting handlers and/or equipment when the horse is being groomed, bathed, walked or worked with in any way and to otherwise amuse the horse when left unattended. The device preferably consists of a curved elongated elastomer bar with ridges that attaches to the horse's halter with webbing and snaps. When the device is attached to the halter within easy reach of the horse's mouth, the horse is able to nibble at, chew on and bite on the elongated elastomer bar. This device provides an outlet for the horse's natural urge to chew and bite and helps to prevent the horse from biting handlers and/or chewing on equipment.

### BACKGROUND OF THE INVENTION

Many horses have a natural tendency or develop the habit of chewing and biting. While being worked with, i.e., groomed, bathed, shod, hand-walked, or having veterinary work done, some horses will bite the handler or chew on equipment. Previously known inventions have attempted to deter destructive chewing by installing rotating wheels affixed to the walls of the horse's stall that the horse might chew on (see U.S. Pat. No. 4,825,812, Horse Pacifier) and by providing, within the close proximity of the horse, devices which might entertain and amuse the horse if the horse is so inclined to kick around and lift the device with its mouth (see U.S. Pat. Nos. 5,351,652 and 5,377,625, Recreational and Amusement Devices for Horses). These latter devices suffer from the drawback that the horse must either be in a fixed location or the devices must be manually moved to a location within easy reach of the horse. As far as it is known there has not been an effective device developed that not only functions as a chewable distraction while the horse is being worked on but also moves along with the horse and will keep the handler safe and equipment intact.

### SUMMARY OF INVENTION

One embodiment of the present invention relates to providing a horse with a distraction while the horse is being worked on, groomed, walked, treated by a veterinarian, or otherwise given attention or when the horse is unattended. Another embodiment of the present invention relates to providing a horse with an alternative object that is within easy reach of the horse's mouth and is not destroyed or consumed that the horse can chew on other than the handler or veterinarian or equipment. Another feature of the present invention is to provide a distracting object that moves with the horse as the horse is moved around, walked or given attention. An additional feature of the present invention is its safety aspect that helps to insure the safety of the horse by providing a device that releases when snagged or entangled on a protrusion. These embodiments are achieved when the present invention, comprising an elongated resilient bar affixed to strapping and affixed to a pressure sensitive release device which is then affixed to bolt snaps, is attached to the horse's halter so that it hangs or dangles just below the horse's nose and mouth but is within easy reach of the horse's mouth so the horse can chew on it at will. In the preferred embodiment, the center portion of the elongated resilient bar is curved and has a plurality of ridges to give the horse more tactile stimulation. Scents or flavors may be added to the elongated resilient bar to enhance the horse's attraction to the bar.

### BRIEF DESCRIPTION OF THE DRAWINGS

FIG. 1 is a perspective view of the assembled components of the present invention.

FIG. 2 is an illustrative drawing of the present invention attached to the halter of a horse.

FIG. 3 is a side view of the elongated resilient bar of the present invention (FIG. 3B) and cross-section view of the said elongated resilient bar (FIG. 3A).

In addition to those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DESCRIPTION OF THE PREFERRED EMBODIMENTS

As required, detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative and not restrictive. The figures are not necessarily to scale; some features may be exaggerated to show details of particular components. Therefore, specific structural and functional details disclosed herein are not to be interpreted as limiting, but merely as a basis for the claims and as a representative basis for teaching one skill in the art to variously employ the present invention.

In summary, the preferred embodiment of the present invention, an equine amusement, distraction and chew device, may be constructed of a elongated curved resilient bar with a plurality of ridges centrally located, wherein the resilient bar is connected by polypropylene fabric woven strapping at one end to a malleable iron bolt snap, and the opposite end is connected by polypropylene fabric woven strapping to a pressure sensitive release mechanism which is then further connected by polypropylene fabric woven strapping to a malleable iron bolt snap. The resilient bar is normally constructed of an elastomer or natural rubber material of suitable hardness and resistance to tear when chewed upon by a horse. The bolt snaps are used to affix the present invention to the horse's halter.

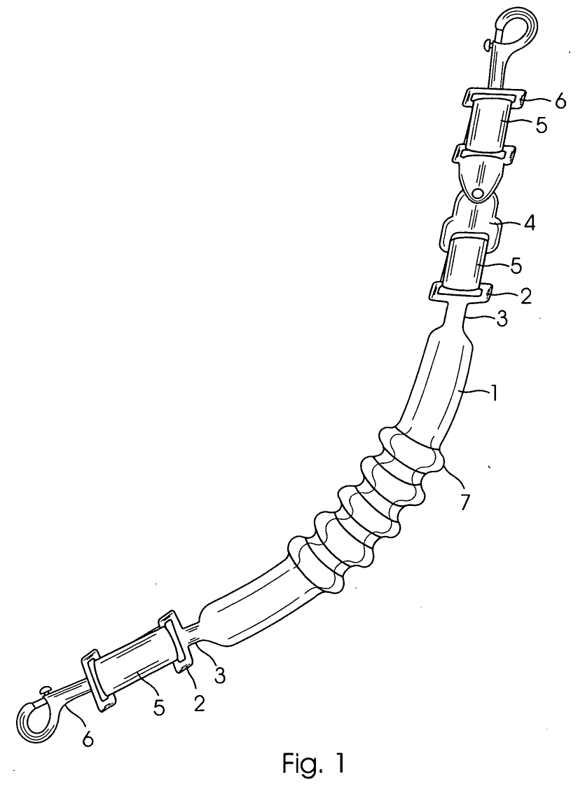

Referring now to FIG. 1, a perspective view of one embodiment of the present invention is shown. As seen in this FIG. 1, Numeral 1 designates an elongated curved cast or molded round resilient bar. In this embodiment the elongated resilient bar narrows at each end (Numeral 3) and a slot or oblong eye (Number 2) is constructed at each end to accommodate a strap. The resilient bar is embossed with a plurality of ridges (Numeral 7) for the purpose of giving the horse more tactile stimulation when chewing on the bar.

Still referring to FIG. 1, looped through the slot or oblong eye (Numeral 2) at each end of the elongated curved resilient bar (Numeral 1) is a strap (Numeral 5). The strap (Numeral 5) is normally constructed of material such as polypropylene fabric weaved in strapping. The strap (Numeral 5) is normally secured or affixed to the slot or square eye (Numeral 2) by stitching.

Still referring to FIG. 1, at one end of the said elongated round resilient bar (Numeral 1) the strap (Numeral 5) is affixed directly to a square eye bolt snap (Numeral 6), normally using stitching to secure the attachment.

Again referring to FIG. 1, in this embodiment, at one of the said elongated resilient bar (Numeral 1) the strap (Numeral 5), which is affixed to said slot or oblong eye of the said elongated resilient bar, is affixed to a safety pressure sensitive release mechanism (Numeral 4). An example of a pressure sensitive release mechanism of the type used in this embodiment presentation is more thoroughly described in U.S. Pat. No. 6,360,401 B1 (and is described therein as a “break-away buckle”). The pressure sensitive release mechanism or break-away buckle is attached by a strap to a bolt snap (Numeral 6), which said bolt snap is used to attach the present invention to the horse's halter. The purpose of the pressure sensitive release mechanism (e.g., break-away buckle) is to allow the present invention to break free in the event it becomes entangled on a protrusion so that the present invention does not endanger the horse's health or safety.

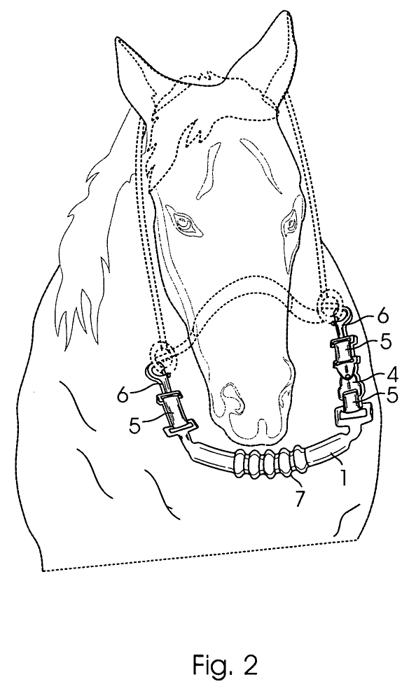

Referring now to FIG. 2, an illustrative drawing of the present invention attached to the halter of a horse is presented. As presented in this FIG. 2, the elongated resilient bar (Numeral 1) is positioned just below the horse's mouth such that the horse's mouth or lips can reach the said elongated resilient bar by movements of its head up and down thereby allowing the horse to nibble or chew on the said elongated resilient bar at will.

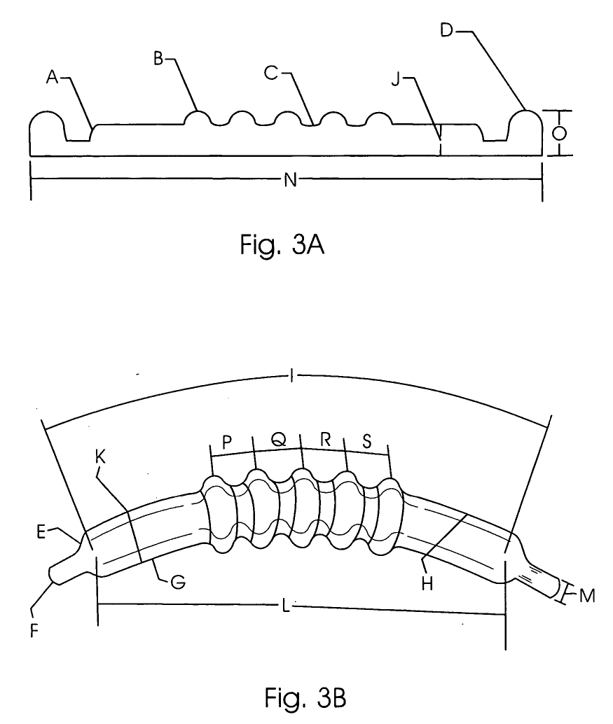

Referring now to FIG. 3., a side view of the elongated round resilient bar (Numeral 1 of FIG. 1) is presented along with a cross-sectional view of the said elongated resilient bar. Example dimensions for this preferred embodiment are setforth in the Table 1 wherein the identifying letter corresponds to the letters setforth in FIG. 3.

TABLE 1

| Designation | Example Dimension | |
|---|---|---|
| A | Radius 0.500 | inches |
| B | Radius 0.250 | inches |
| C | Radius 0.200 | inches |
| D | Radius 0.375 | inches |
| E | Radius 0.188 | inches |
| F | Radius 0.187 | inches |
| G | Radius 9.341 | inches |
| H | Radius 10.341 | inches |
| I | 48.6 | degrees |
| J | 0.500 | inches |
| K | 1.00 | inches |
| L | 8.099 | inches |
| M | 0.375 | inches |
| N | 11.031 | inches |
| O | 0.750 | inches |
| P | 0.894 | inches |
| Q | 0.901 | inches |
| R | 0.901 | inches |
| S | 0.894 | inches |

As noted in FIG. 3, in this preferred embodiment the elongated resilient bar is curved. In this preferred embodiment the curvature facilitates the positioning of the elongated resilient bar in a location that allows the horse to nibble or chew on the bar at will (as depicted in FIG. 2). It is to be understood that the dimensions as provided in FIG. 3 are illustrative and not restrictive.

In its preferred embodiment, the elongated resilient bar (Numeral 1 of FIG. 1) is normally constructed of an resilient bar with characteristics capable of resisting destruction when chewed on by a horse. The said resilient bar is preferably constructed of a material that is safe for the horse to chew upon and is of a hardness that provides tactile stimulation to the horse. In this preferred embodiment the elongated resilient bar is constructed, as an example, of a food grade black stock natural sheet gum rubber with 40 Durometer hardness on the Shore A scale, a Specific Gravity of 1.07, Tensile Strength of 3818 pounds, Modulus at 30% of 861, Elongation of 602 inches and Tear of 368 pounds. Once again, it is to be understood that these characteristics are illustrative and not restrictive.

While a number of embodiments of the present invention have been described, it is understood that these embodiments are illustrative only, and not restrictive, and that many of these modifications may become apparent to those of ordinary skill in the art. For example, bolt snaps could be replaced with spring snaps or other suitable clasps. Sill further, rigid-eye bolt snaps could be replaced with swivel-eye bolt snaps. Still further, square eye bolt snaps could be replaced with round eye or double end bolt snaps. The malleable iron bolt snaps could be manufactured from a variety of materials including but not limited to stainless steel, bronze, brass, other alloys, plastic or other suitable materials of construction. Still further the resilient bar may be colored, scented and/or flavored as desired (e.g., to appeal to a horse owner and/or the horse in terms of smell and/or taste and/or visual appearance). Further still, the distance the elongated resilient bar dangles below the horse's nose or mouth may be varied and even, if desirable, raised to rest within the horse's mouth in order to facilitate the horse's desire to chew and/or distract the horse from chewing on the handler or equipment. In order to facilitate the position of the elongated resilient bar, an adjustment mechanism may be affixed to the strap at one end of said elongated resilient bar in order that the strap length can be varied as desired. Still further some methods used for the manufacture of the resilient bar in addition to molding or casting might include machining or extrusion. Further still, the plurality of ridges could be any desired distance apart, any desired height, any desired number, or any desired pattern and could be replaced by nubs, bumps or bristles or eliminated entirely. Further still, the dimensions of the resilient bar could be increased or decreased as desired. Further still, the polypropylene fabric weaved into strap could be replaced with nylon, polyester or similar material or a natural fabric such as cotton or replaced with leather or plastic strap. Still further, the strap could vary in diameter, and a round cord or rope or weaved nylon or chain or the like could replace the strap. Still further, the strap could be affixed to the resilient bar and the snap bolts by attachment methods other than stitching or sewing (e.g., buttons or rivets). Still further, the shape of the round rubber bar could be oval, rectangle or square in configuration and could be tubular or hollow in construction. Still further, the natural rubber composition of the round bar could be replaced with synthetic elastomers. Still further, a variety of mechanisms could be employed to give the effect or serve the purpose of the pressure release mechanism, including but not limited to, a plurality of release mechanisms, snaps, and related devices designed to release under pressure.

The invention claimed is:

1. An amusement, distraction and chew device for a horse comprising:
A resilient body capable of resisting destruction when chewed on by a horse,
Wherein said body has the shape of a elongated curved bar,
Wherein said body is of a size and configuration suitable for a horse to engage with its lips and teeth,
Wherein said body has a method for connection at each end that will enable the said body to be connected to the halter of a horse.

2. The amusement, distraction and chew device of claim 1 wherein the said resilient body is composed of an elastomer.

3. The amusement, distraction and chew device of claim 1 wherein the said resilient body is composed of natural rubber.

4. The amusement, distraction and chew device of claim 1 wherein the said resilient body is composed of a synthetic rubber.

5. The amusement, distraction and chew device of claim 1 wherein the elongated curved bar body has a plurality of ridges.

6. The amusement, distraction and chew device of claim 1 wherein strap and bolt snaps are used to adhere the elongated curved bar to the horse's halter.

7. The amusement, distraction and chew device of claim 1 wherein a pressure sensitive release mechanism is affixed between the elongated curved bar body of the device and the connection to the horse's halter that will enable the device to release or break free if the device becomes entangled or snagged on a protrusion.

8. The amusement, distraction and chew device of claim 1 wherein the body of the elongated resilient bar is impregnated with an aroma-producing substance to emit an odor of food for horses.

9. The amusement, distraction and chew device of claim 1 wherein the body of the elongated resilient bar is impregnated with a flavor-producing substance that is attractive to horses.

10. The amusement, distraction and chew device of claim 1 wherein the strap used to affix the elongated curved bar to the horse's halter has a mechanism to allow for the adjustment of the length of the strap thereby allowing for the adjustment of the distance the elongated curve bar hangs from the halter.

11. The distraction and chew device of claim 7 wherein a pressure sensitive release mechanism is connected to one end of the elongated resilient bar and to the eye end of the bolt snap where said bolt snap is connected to the horse's halter, all of which are connected together in a manner that allows the device to break free if snagged or entangled on a protrusion.

12. The distraction and chew device of claim 7 wherein a pressure sensitive release mechanism is connected by a strap to one end of the elongated resilient bar and the other end of the release mechanism is connected to the strap which is then connected to the eye end of the bolt snap where said bolt snap is connected to the horse's halter all of which are connected together in a manner that allows the device to break free if snagged or entangled on a protrusion.

13. An amusement, distraction and chew device in combination with a pressure sensitive release mechanism to release the device in the event it becomes entangled or snagged on a protrusion and a method for connection to the halter of a horse that allows the chew component of the device to be positioned just below the horse's mouth, consisting essentially of:
A resilient body capable of resisting destruction when chewed on by a horse,
Wherein said body has the shape of a elongated curved bar,
Wherein said body is of a size and configuration suitable for a horse to engage with its lips and teeth,
Wherein said body has a method for connection at each end that will enable the said body to the halter of a horse.
A method for adhering the device to the horse's halter so the device hangs below the horse's mouth and can be chewed on by the horse at will,
A mechanism to allow the device to release if the device becomes snagged or entangled.

14. An amusement, distraction and chew device of claim 13 wherein the said resilient body is composed of elastomer.

15. An amusement, distraction and chew device of claim 13 wherein the said resilient body is composed of natural rubber.

16. An amusement, distraction and chew device of claim 13 wherein the said resilient body is composed of synthetic rubber.

17. An amusement, distraction and chew device of claim 13 wherein the body of the elongated resilient bar is embossed with a plurality of ridges.

18. An amusement, distraction and chew device of claim 13 wherein the elongated curved resilient bar is connected to the halter with strap and bolt snaps.

19. An amusement, distraction and chew device of claim 13 wherein the elongated curved bar is connected to a pressure sensitive release mechanism with a strap and where the pressure sensitive release mechanism is connected to a bolt snap which is used to connect the elongated curved bar to the horse's halter so as to enable the device to release in the event it should become entangled or snagged on a protrusion.

20. An amusement distraction and chew device of claim 19 wherein the pressure sensitive release mechanism is a break-away buckle.

21. An amusement distraction and chew device of claim 18 wherein the strap has a mechanism for adjusting the length of the strap.
